(19) United States
(12) Patent Application Publication
(10) Pub. No.: US 2010/0181255 A1
(43) Pub. Date: Jul. 22, 2010

(54) METHOD AND DEVICE FOR ELIMINATING FOREIGN MATTERS PRESENT IN DISSOLVED FORM FROM WASTE WATER

(76) Inventors: Michael Riebensahm, Santiago (CL); Markus Vöge, München (DE)

Correspondence Address: King & Spalding LLP, 401 Congress Avenue, Suite 3200, Austin, TX, 78701, US

(21) Appl. No.: 12/376,585

(22) PCT Filed: Aug. 8, 2007
(86) PCT No.: PCT/EP07/58248

§ 371 Date: Mar. 16, 2010

(30) Foreign Application Priority Data
Aug. 16, 2006 (DE) 102006038206.4

(51) Int. Cl. C02F 1/48; C02F 1/62; C02F 1/52; C02F 1/28; C02F 1/36

(52) U.S. Cl. 210/675; 210/695; 210/222

(57) ABSTRACT

A method for continuously eliminating foreign matter, may have the following steps: a) through-flow of a reactor with waste water in a flow direction, b) adding of magnetic or magnetizable particles to a feeding point in the reactor, wherein at least one foreign matter is attached to the particles, c) separating of particles charged with foreign matter to another spot in the reactor, located opposite the feeding point in the downward flow direction by applying a magnetic field to the water flow for the transport of particles into a collecting area connected fluidic with the reactor and d) separating of the particles and the foreign matter connected to the particles from each other. A device may have a reactor receiving waste water polluted with pollutants, a collecting area for polluted magnetic or magnetizable particles, and may produce a magnetic field, transporting the particles into the collecting area.

### CROSS-REFERENCE TO RELATED APPLICATIONS

This application is a U.S. National Stage Application of International Application No. PCT/EP2007/058248 filed Aug. 8, 2007, which designates the United States of America, and claims priority to German Application No. 10 2006 038 206.4 filed Aug. 16, 2006, the contents of which are hereby incorporated by reference in their entirety.

### TECHNICAL FIELD

The invention relates to a device and a method for continuous elimination from wastewater of foreign matters present in dissolved form.

### BACKGROUND

Foreign matters are taken to mean substances which interfere for ecological, economic or other reasons, and must therefore be removed from the wastewater. Whereas foreign matters present in the form, for instance, of solid particles, can be eliminated in a relatively problem-free manner by mechanical methods, chemical methods are usually required for separating off dissolved foreign matters. For example, wastewaters produced in ore recovery contain large amounts of sulfates and heavy metals. The sulfates were conventionally precipitated out as calcium sulfate by adding milk of lime. However, use of the calcium sulfate for producing gypsum products is not possible, because of the contamination of the precipitated sulfate sludges with heavy metals, such that usually only costly landfilling comes into consideration.

DE 27 19 529 A1 discloses a coagulant and adsorbent for water clarification. The particulate adsorbent consists of a finely divided mineral or clay material. The individual particles have a thin hydroxylated surface layer, which layer has a positive zeta potential at the adsorption pH. The particles which are added to the water which is to be clarified bind, after intensive stirring, to the pollutants present in the water. Subsequently, there is a waiting time for the particles to sediment. The sedimentation can be accelerated by using a magnetic separator.

DE 695 16 322 T2 discloses magnetic particles for purifying solutions, and also a method for producing such particles. The particles have a magnetic core around which is wound a fibrous material. The fibrous material is in turn impregnated by a binder. The core can consist of iron oxide or of another magnetic material. The fibrous material can, in particular, be an organic polymer. The magnetic particles can be eliminated from the solution which is to be purified by means of methods known in general from the prior art with the use of magnetic forces.

DE 101 60 664 A1 discloses a method of purifying wastewater, and also an adsorbent having magnetic properties which is suitable for this method. The wastewater which is to be purified is brought into contact with the magnetic adsorbent for a sufficiently long time, subsequently the mixture of wastewater and adsorbent is exposed to a magnetic field. For example, the wastewater can be passed through a tube in which a magnetic filter is situated. Such a magnetic filter can be formed by a grating of magnetizable material, an arrangement of magnetic rods, by steel wool, or iron filings.

### SUMMARY

According to various embodiments, a method can be proposed which permits simple and effective separation of foreign matters from a wastewater which is to be purified. In particular, according to various embodiments, a method can be specified by which, in a simple manner, separate elimination of heavy metals and sulfates from wastewaters can be achieved. According to further embodiments, a device can be specified which is suitable for carrying out the method.

According to an embodiment, a method for the continuous elimination from wastewater of foreign matters present in dissolved form, may comprise the following steps: a) wastewater flows through a reactor in a flow direction, b) adding magnetic or magnetizable particles at a feed site of the reactor to the wastewater, wherein at least one foreign matter attaches to the particles, c) separating off particles loaded with foreign matter at a further site of the reactor which is situated downstream from the feed site in the flow direction by subjecting the wastewater stream to a magnetic field for transporting the particles into a collecting region which is fluid-connected to the reactor and d) separating the particles and the foreign matters adhering to the particles from one another.

According to a further embodiment, foreign matters may attach to the particles by adsorption. According to a further embodiment, the particles can be provided with a coating, in which, or on the surface of which, foreign matters accumulate. According to a further embodiment, particles and foreign matters may be separated by strong turbulence being generated in a pollutant-loaded particle-containing suspension. According to a further embodiment, the particles and foreign matters may be separated by the foreign matter-loaded particles being treated with ultrasound. According to a further embodiment, According to a further embodiment, particles may have a specific binding action for the selective binding of foreign matters. According to a further embodiment, the foreign matters can be heavy metals. According to a further embodiment, the method may comprise the step: e) precipitating out sulfate which is present in the wastewater. According to a further embodiment,—first and second magnetic or magnetizable particles may be added to the wastewater at a first feed site and a second feed site, wherein at least one first foreign matter and one second foreign matter attach to the first and second particles,—separation of first and second particles at respectively a further first and second point of the reactor which can be situated downstream in the flow direction of the first and second feed sites. According to a further embodiment, the first foreign matter may be sulfate and the second foreign matter may be a heavy metal.

According to another embodiment, a device may be operable to carry out such a method and may comprise a reactor receiving wastewater polluted with pollutants, which reactor has at least one collecting region for pollutant-loaded magnetic or magnetizable particles, and means for generating a magnetic field which transports the particles to the at least one collecting region.

According to a further embodiment, the at least one collecting region can be enclosed by at least one magnetic coil. According to a further embodiment, the device may comprise a tubular reactor, on the outside of which is arranged at least one collecting region which is fluid-connected to the reactor. According to a further embodiment, the device may comprise a plurality of collecting regions which are spaced apart in the longitudinal direction of the reactor.

### BRIEF DESCRIPTION OF THE DRAWINGS

FIG. 1 shows schematically a reactor.

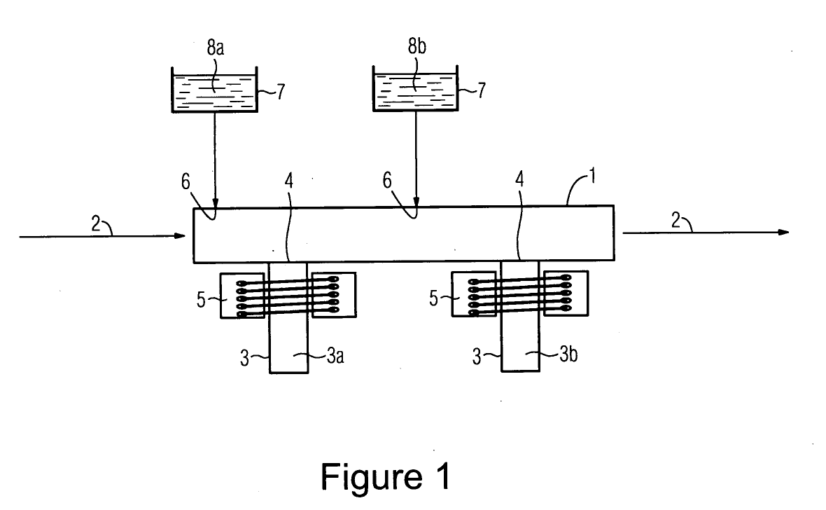

### DETAILED DESCRIPTION

In one method, magnetic or magnetizable particles are added to the wastewater, to which magnetic or magnetizable particles at least one foreign matter attaches. The pollutant-loaded particles are then, using a magnetic field, separated off from the wastewater and subsequently subjected to a treatment in which the particles and adhering pollutants are separated from one another again. In particular, the method according to an embodiment serves for the continuous elimination of foreign matters which are present in the wastewater in dissolved form. In this case wastewater flows through a reactor in a flow direction. At a feed site of the reactor, magnetic or magnetizable particles are added to the wastewater, to which magnetic or magnetizable particles at least one foreign matter attaches. At a further site of the reactor which is situated downstream in the flow direction, the particles which are loaded with foreign matter are separated off into a collecting region which is fluid-connected to the reactor by exposing the wastewater to a magnetic field. The particles and the foreign matter adhering to the particles are later separated from one another. Owing to the specific binding action of the particles, foreign matters can be separated off from the wastewater in a targeted manner, such that separation of the foreign matters into single varieties succeeds. As a result, for example, the possibilities for meaningful reutilization of the foreign matters are increased. In the case of sulfate wastewaters which contain heavy metals, the heavy metals may be removed separately from the wastewater with relatively little expenditure, in such a manner that the remaining sulfate can be eliminated as heavy metal-free calcium sulfate using conventional methods, or preferably likewise using magnetic or magnetizable particles. The particles and foreign matters adhering to them are separated from one another in a final method step, in such a manner that the particles firstly do not interfere in the reutilization and secondly can be reutilized for removing foreign matters from wastewater.

In what manner said separation is performed ultimately depends on the type of binding between particles and foreign matters. In the case of adhesion of the foreign matters by adsorption to the particles, mechanical methods, for example treatment with ultrasound, can be used. It is also conceivable to generate strong turbulence in a suspension of particles which are loaded with foreign matters and thereby separate the foreign matters and particles. In the case of chemical binding between particles and foreign matter, chemical methods are used. Thus, for example, particles can be used, at the surface of which, groups known from ion exchangers such as, for instance, sulfonic acid groups, are present for binding cations, or quaternary ammonium groups, or else chelate-forming groups for binding anions. The separation of foreign matters can be performed in this case in the same manner as the regeneration of corresponding ion exchangers, for example in the case of acid groups, by treatment with acids, wherein a particle-bound cation, for instance a heavy metal cation, is replaced by one or more protons.

Binding of foreign matters to particles may also be effected by the particles being provided with a coating in which, or on the surface of which, certain foreign matters accumulate. The coating in this case could comprise a substance which effects adhesion by adsorption of foreign matters or which has the abovementioned groups.

In another embodiment, wastewaters containing sulfate and heavy metals as foreign matters are purified, wherein, preferably, first the heavy metals are eliminated using magnetic or magnetizable particles before the sulfate is separated off. The sulfate can subsequently be separated off using conventional methods or likewise with the aid of the particles in question. After separating off the particles from the heavy metals, these can be reutilized, for example, in ore recovery. In a further preferred method variant, selective separation proceeds by adding particles to the wastewater, to which particles only a single heavy metal attaches, or only some of the heavy metals contained in the wastewater attach. In this manner, e.g., defined heavy metals which interfere during reutilization can be eliminated. A device which is suitable for carrying out a method of the type described comprises a reactor serving for receiving wastewater polluted with foreign matters, which reactor has a collecting region for foreign-matter loaded magnetic or magnetizable particles, and also means for generating a magnetic field which transports the particles to the collecting region. The magnetic field is preferably generated by at least one magnetic coil which encloses the collecting region.

In a device variant, the reactor is constructed so as to be tubular. Such a reactor is suitable, particularly, for continuous elimination of foreign matters. The wastewater to be purified flows through the reactor, wherein at one site, addition of magnetic or magnetizable particles, and at a reactor site situated downstream, the wastewater stream is subjected to a magnetic field in order to transport the particles which are loaded with foreign matter to a collecting region which is fluid-connected to the reactor. In the event that a plurality of different foreign matters must be separated off selectively, at the reactor a plurality of collecting regions are available which are spaced apart in the longitudinal direction of the reactor, and/or in the flow direction of the wastewater.

Such a reactor 1 is shown schematically in the accompanying drawing. The reactor 1 is arranged essentially horizontally and, in operation, a wastewater stream flows through it, for example in the direction of the arrows 2. At the outer periphery of the reactor 1, containers 3 of roughly cylindrical shape which are spaced apart in the longitudinal direction of the reactor and/or in the flow direction are arranged which form a collecting region 3a for the particles which are separated off from the wastewater. The containers 3 are fluid-connected to the reactor 1 via an opening 4. The containers 3 are each encircled by a magnetic coil 5 in a longitudinal section close to the opening 4. In each case, at a position of the reactor 1 which is situated upstream of a container 3, a feed site 6 is provided via which a suspension 8a, 8b which contains magnetic or magnetizable particles can be introduced into the wastewater. The feed is performed from a reservoir 7 which is arranged at a geodetically higher position compared with the reactor 1, in such a manner that a pump is not required for feeding in the particle suspension 8a, 8b. The distance between a feed site 6 and a collecting region 3a is selected in such a manner that for a predetermined flow velocity of the wastewater, complete coupling between the particles of the particle suspension 8a, 8b and the respective foreign matter is ensured. The magnetic field of the magnetic coil 5 is selected in such a manner that the force acting on the particles which are loaded with foreign matter is sufficient, at a given flow velocity of the wastewater, to transport the particles completely out of the reactor and into the collecting region 3. If appropriate, the force is sufficiently great to transport particles even against the force of gravity. Depending on the type of foreign matter to be eliminated, the distance between feed site 6 and collecting container 3a can vary.

What is claimed is:

1. A method for the continuous elimination from wastewater of foreign matters present in dissolved form, the following steps:
a) wastewater flows through a reactor in a flow direction,
b) adding magnetic or magnetizable particles at a feed site of the reactor to the wastewater, wherein at least one foreign matter attaches to the particles,
c) separating off particles loaded with foreign matter at a further site of the reactor which is situated downstream from the feed site in the flow direction by subjecting the wastewater stream to a magnetic field for transporting the particles into a collecting region which is fluid-connected to the reactor and
d) separating the particles and the foreign matters adhering to the particles from one another.

2. The method as claimed in claim 1, wherein foreign matters attach to the particles by adsorption.

3. The method as claimed in claim 1, wherein the particles are provided with a coating, in which, or on the surface of which, foreign matters accumulate.

4. The method as claimed in claim 1, wherein particles and foreign matters are separated by strong turbulence being generated in a pollutant-loaded particle-containing suspension.

5. The method in claim 1, wherein the particles and foreign matters are separated by the foreign matter-loaded particles being treated with ultrasound.

6. The method in claim 1, with particles having a specific binding action for the selective binding of foreign matters.

7. The method as claimed in claim 6, wherein the foreign matters are heavy metals.

8. The method as claimed in claim 7, comprising the step:
e) precipitating out sulfate which is present in the wastewater.

9. The method as claimed in claim 6, wherein
first and second magnetic or magnetizable particles are added to the wastewater at a first feed site and a second feed site, wherein at least one first foreign matter and one second foreign matter attach to the first and second particles,
separation of first and second particles at respectively a further first and second point of the reactor which are situated downstream in the flow direction of the first and second feed sites.

10. The method as claimed in claim 9, wherein the first foreign matter is sulfate and the second foreign matter is a heavy metal.

11. A device operable to carry out a method as claimed in claim 1 comprising a reactor receiving wastewater polluted with pollutants, which reactor has at least one collecting region for pollutant-loaded magnetic or magnetizable particles, and means for generating a magnetic field which transports the particles to the at least one collecting region.

12. The device as claimed in claim 11, wherein the at least one collecting region is enclosed by at least one magnetic coil.

13. The device as claimed in claim 11, comprising a tubular reactor, on the outside of which is arranged at least one collecting region which is fluid-connected to the reactor.

14. The device as claimed in claim 13, comprising a plurality of collecting regions which are spaced apart in the longitudinal direction of the reactor.
